(19) United States
(12) Patent Application Publication
(10) Pub. No.: US 2022/0373067 A1
(43) Pub. Date: Nov. 24, 2022

(54) POWERTRAIN APPARATUS FOR ELECTRIC VEHICLE

(71) Applicants: Hyundai Motor Company, Seoul (KR); Kia Corporation, Seoul (KR)

(72) Inventors: Hyu Tae SHIM, Hwaseong-Si (KR); Jin Seung LIM, Seoul (KR); Jae Young JEON, Seongnam-Si (KR); Jun Seong KANG, Gwacheon-Si (KR); Jong Min KIM, Hanam-Si (KR); Jae Hun JUNG, Incheon (KR)

(73) Assignees: Hyundai Motor Company, Seoul (KR); Kia Corporation, Seoul (KR)

(21) Appl. No.: 17/507,583

(22) Filed: Oct. 21, 2021

(30) Foreign Application Priority Data
May 21, 2021 (KR) 10-2021-0065770

(51) Int. Cl. F16H 37/08; B60K 1/00; B60K 17/08; B60K 17/16; F16D 21/00; B60K 17/02

(52) U.S. Cl. CPC F16H 37/082; B60K 1/00; B60K 17/08; B60K 17/165; F16D 21/00; B60K 17/02; B60K 2001/001; F16H 2200/2007; F16H 2200/0021; F16H 2200/2038; F16H 2702/02; F16H 2200/0039; F16H 2200/2066; F16H 2200/2064; F16H 2200/2082; F16H 2200/2094; F16H 2200/2041

(57) ABSTRACT

A powertrain apparatus includes a motor connected to an input shaft, a first planetary gear train, which is disposed to be coaxial with the motor and which includes a first rotation element, a second rotation element, and a third rotation element, a second planetary gear train, which is disposed to be coaxial with the first planetary gear train and which includes a fourth rotation element, a fifth rotation element, a sixth rotation element, and a step pinion, and a differential gear, which is disposed to be coaxial with the second planetary gear train.

### CROSS-REFERENCE TO RELATED APPLICATION

The present application claims priority to Korean Patent Application No. 10-2021-0065770, filed on May 21, 2021, the entire contents of which is incorporated herein for all purposes by this reference.

### BACKGROUND OF THE INVENTION

### Field of the Invention

The present invention relates to a powertrain apparatus structure for an electric vehicle or the like.

### Description of Related Art

Conventionally, because a powertrain apparatus for an electric vehicle, which is configured to reduce the speed of the power from a motor using external gears and transmit the power to a drive wheel, has at least a triaxial structure, a relatively large space is required to mount the powertrain apparatus in a vehicle, and which is disadvantageous from the aspect of ensuring internal space in a vehicle. Furthermore, it is difficult to satisfy both a desired acceleration performance and the maximum speed performance using only one speed reduction ratio in a high-performance and large-sized vehicle.

The information disclosed in this Background of the present invention section is only for enhancement of understanding of the general background of the present invention and may not be taken as an acknowledgement or any form of suggestion that this information forms the prior art already known to a person skilled in the art.

### BRIEF SUMMARY

Various aspects of the present invention are directed to providing a powertrain apparatus for an electric vehicle, which is constructed to have a compact structure to be easily and efficiently mounted in a vehicle, which is advantageous in maximizing available internal space in the vehicle and which is configured for easily realizing desired rapid acceleration performance and maximum speed performance even in a high-performance and large-sized vehicle and of improving efficiency of battery consumption by providing a plurality of changeable speeds.

In accordance with various aspects of the present invention, the above and other objects may be accomplished by the provision of a powertrain apparatus for an electric vehicle including a motor connected to an input shaft, a first planetary gear train, which is disposed to be coaxial with the motor and which includes a first rotation element, a second rotation element and a third rotation element, a second planetary gear train, which is disposed to be coaxial with the first planetary gear train and which includes a fourth rotation element, a fifth rotation element, a sixth rotation element, and a step pinion, and a differential gear, which is disposed to be coaxial with and engaged to the second planetary gear train, wherein the rotation elements of the first planetary gear train are configured to reduce the speed of power transmitted from the input shaft and transmit the reduced power to the second planetary gear train, wherein the fourth, fifth and sixth rotation elements of the second planetary gear train reduce the speed of power transmitted from the first planetary gear train and transmit the reduced power of the second planetary gear train to the differential gear via the fifth rotation element, and wherein the fifth rotation element is a rotation shaft of the step pinion, in which a first pinion and a second pinion are integrally connected to each other, and is fixedly connected to the differential gear.

One of driveshafts coupled to the differential gear may be coupled to the differential gear through centers of the first planetary gear train, the second planetary gear train, and the input shaft.

The first pinion of the step pinion may have a diameter greater than that of the second pinion, the fourth rotation element may be engaged with the first pinion of the step pinion, and the sixth rotation element may be engaged with the second pinion of the step pinion, and may be fixed to the housing.

The first rotation element may be fixedly connected to the input shaft, the second rotation element may be fixedly connected to the fourth rotation element, and the third rotation element may be fixedly coupled to the housing.

The fourth rotation element may be selectively connectable to the input shaft via a first clutch, and the third rotation element may be fixedly coupled to the housing via a brake.

The fourth rotation element may be selectively connectable to the input shaft via a first clutch, and the third rotation element may be fixedly coupled to the housing via a one-way clutch and a dog clutch.

The first rotation element and the second rotation element may be selectively connectable to the input shaft via a first dog clutch and a second dog clutch, respectively, and the third rotation element may be fixed to the housing.

The first rotation element may be fixed to the housing and the third rotation element and the second rotation element may be selectively connectable to the input shaft via a first dog clutch and a second dog clutch.

The second planetary gear train may further include a seventh rotation element engaged with the second pinion of the step pinion, and the seventh rotation element may be selectively connectable to the input shaft via a second clutch.

The first rotation element may be fixedly connected to the input shaft, the second rotation element may be fixedly connected to the fourth rotation element, and the third rotation element may be fixedly coupled to the housing.

The fourth rotation element may be selectively connectable to the input shaft via a first clutch, and the third rotation element may be fixedly coupled to the housing via a brake.

The fourth rotation element may be selectively connectable to the input shaft via a first clutch and the first rotation element may be fixedly coupled to the housing via a one-way clutch and a dog clutch.

The second planetary gear train may further include a seventh rotation element engaged with the second pinion of the step pinion, the first rotation element may be fixedly connected to the input shaft, the third rotation element may be fixedly coupled to the housing via a one-way clutch and a first dog clutch, which are disposed to be parallel to each other, the second rotation element and the fourth rotation element may be fixedly connected to each other, and the second rotation element and the seventh rotation element may be selectively connectable to the input shaft via a second dog clutch and a third dog clutch, respectively.

The second planetary gear train may further include a seventh rotation element engaged with the second pinion of the step pinion, the first rotation element may be fixedly coupled to the housing via a one-way clutch and a first dog clutch, which are disposed to be parallel to each other, the third rotation element may be fixedly connected to the input shaft, the second rotation element may be fixedly connected to the fourth rotation element, and the second rotation element and the seventh rotation element may be selectively connectable to the input shaft via a second dog clutch and a third dog clutch, respectively.

The first rotation element may be selectively connectable to the input shaft via a third clutch, the second rotation element may be fixedly connected to the fourth rotation element, and the third rotation element may be fixed to the housing.

The fourth rotation element may be selectively connectable to the input shaft via a first clutch.

The first rotation element may be selectively connectable to the input shaft via a one-way clutch and a dog clutch, which are disposed to be parallel to each other, the second rotation element may be fixedly connected to the fourth rotation element and may be selectively connectable to the input shaft via a first clutch, and the third rotation element may be fixed to the housing.

The first rotation element may be fixed to the housing, the second rotation element may be fixedly connected to the fourth rotation element and may be selectively connectable to the input shaft via a first clutch, and the third rotation element may be selectively connectable to the input shaft via a third clutch.

The first rotation element may be fixed to the housing, the second rotation element may be fixedly connected to the fourth rotation element and may be selectively connectable to the input shaft via a first clutch, and the third rotation element may be selectively connectable to the input shaft via a one-way clutch and a dog clutch, which are disposed to be parallel to each other.

The second planetary gear train may further include a seventh rotation element engaged with the second pinion of the step pinion, the first rotation element may be fixed to the housing, the third rotation element may be selectively connectable to the input shaft via a one-way clutch and a first dog clutch, which are disposed to be parallel to each other, the second rotation element and the fourth rotation element may be fixedly connected to each other, and the second rotation element and the seventh rotation element may be selectively connectable to the input shaft via a second dog clutch and a third dog clutch, respectively.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view exemplarily illustrating a powertrain apparatus for an electric vehicle according to various exemplary embodiments of the present invention;

FIG. 2 is a view exemplarily illustrating the state in which the power train shown in FIG. 1 is operated to realize a first speed;

FIG. 3 is a view exemplarily illustrating the state in which the power train shown in FIG. 1 is operated to realize a second speed;

FIG. 4 is a view exemplarily illustrating a powertrain apparatus for an electric vehicle according to various exemplary embodiments of the present invention;

FIG. 5 is a view exemplarily illustrating a powertrain apparatus for an electric vehicle in which the brake according to the various exemplary embodiments shown in FIG. 4 is replaced with a one-way clutch and a dog clutch;

FIG. 6 is a view exemplarily illustrating a powertrain apparatus for an electric vehicle according to various exemplary embodiments of the present invention;

FIG. 7 is a view exemplarily illustrating a modification of the various exemplary embodiments shown in FIG. 6;

FIG. 8 is a view exemplarily illustrating a powertrain apparatus for an electric vehicle according to various exemplary embodiments of the present invention;

FIG. 9 is a table illustrating operation modes of the various exemplary embodiments shown in FIG. 8;

FIG. 10 is a view exemplarily illustrating the state in which the brake according to the various exemplary embodiments shown in FIG. 8 is replaced with a one-way clutch and a dog clutch;

FIG. 11 is a view exemplarily illustrating the state in which the first clutch and the second clutch according to the exemplary embodiment shown in FIG. 10 are replaced with a second dog clutch and a third dog clutch;

FIG. 12 is a view exemplarily illustrating a modification of the exemplary embodiment shown in FIG. 11;

FIG. 13 is a view exemplarily illustrating a powertrain apparatus for an electric vehicle according to various exemplary embodiments of the present invention;

FIG. 14 is a view exemplarily illustrating the state in which the brake according to the various exemplary embodiments shown in FIG. 13 is replaced with a one-way clutch and a dog clutch;

FIG. 15 is a view exemplarily illustrating a powertrain apparatus for an electric vehicle according to various exemplary embodiments of the present invention;

FIG. 16 is a view exemplarily illustrating the state in which the third clutch according to the various exemplary embodiments shown in FIG. 15 is replaced with a one-way clutch and a dog clutch;

FIG. 17 is a view exemplarily illustrating a modification of the various exemplary embodiments shown in FIG. 15;

FIG. 18 is a view exemplarily illustrating the state in which the third clutch according to the exemplary embodiment shown in FIG. 17 is replaced with a one-way clutch and a dog clutch; and

FIG. 19 is a view exemplarily illustrating the state in which the first clutch and the second clutch according to the exemplary embodiment shown in FIG. 18 are replaced with a second dog clutch and a third dog clutch.

It may be understood that the appended drawings are not necessarily to scale, presenting a somewhat simplified representation of various features illustrative of the basic principles of the present invention. The specific design features of the present invention as included herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the present invention(s) will be described in conjunction with exemplary embodiments of the present invention, it will be understood that the present description is not intended to limit the present invention(s) to those exemplary embodiments. On the other hand, the present invention(s) is/are intended to cover not only the exemplary embodiments of the present invention, but also various alternatives, modifications, equivalents and other embodiments, which may be included within the spirit and scope of the present invention as defined by the appended claims.

Specific structural and functional descriptions of embodiments of the present invention disclosed herein are only for illustrative purposes of the exemplary embodiments of the present invention. The present invention may be embodied in various forms, without departing from the spirit and significant characteristics of the present invention. Therefore, the exemplary embodiments of the present invention are disclosed only for illustrative purposes, and should not be construed as limiting the present invention.

Reference will now be made in detail to various embodiments of the present invention, specific examples of which are illustrated in the accompanying drawings and described below, since the exemplary embodiments of the present invention may be variously modified in various forms. While the present invention will be described in conjunction with exemplary embodiments thereof, it is to be understood that the present description is not intended to limit the present invention to those exemplary embodiments. On the other hand, the present invention is directed to cover not only the exemplary embodiments of the present invention, but also various alternatives, modifications, equivalents and other embodiments which may be included within the spirit and scope of the present invention as defined by the appended claims.

It will be understood that, although the terms “first,” “second,” etc. may be used herein to describe various elements, these elements should not be construed as being limited by these terms. These terms are only used to distinguish one element from another element. For instance, a first element discussed below could be termed a second element without departing from the teachings of the present invention. Similarly, the second element could also be termed the first element.

It will be understood that when an element is referred to as being “coupled” or “connected” to another element, it may be directly coupled or connected to the other element, or intervening elements may be present therebetween. In contrast, it should be understood that when an element is referred to as being “directly coupled” or “directly connected” to another element, there are no intervening elements present. Other expressions that explain the relationships between elements, such as “between,” “directly between,” “adjacent to,” or “directly adjacent to,” should be understood in the same way.

The terminology used herein is for describing various exemplary embodiments only, and is not intended to be limiting. As used herein, the singular forms “a,” “an” and “the” are intended to include the plural forms as well, unless the context clearly indicates otherwise. It will be further understood that the terms “comprise”, “include”, “have”, etc. When used in the exemplary embodiment specify the presence of stated features, integers, steps, operations, elements, components, and/or combinations thereof, but do not preclude the presence or addition of one or more other features, integers, steps, operations, elements, components, and/or combinations thereof.

Unless otherwise defined, all terms including technical and scientific terms used herein have the same meaning as those commonly understood by one of ordinary skill in the art to which the present invention belongs. It will be further understood that terms, such as those defined in commonly used dictionaries, should be interpreted as having meanings consistent with their meanings in the context of the relevant art and the present invention, and are not to be interpreted in an idealized or overly formal sense unless expressly so defined herein.

Hereinafter, various exemplary embodiments of the present invention will be described in detail with reference to the accompanying drawings. Throughout the drawings, the same reference numerals will refer to the same or like portions.

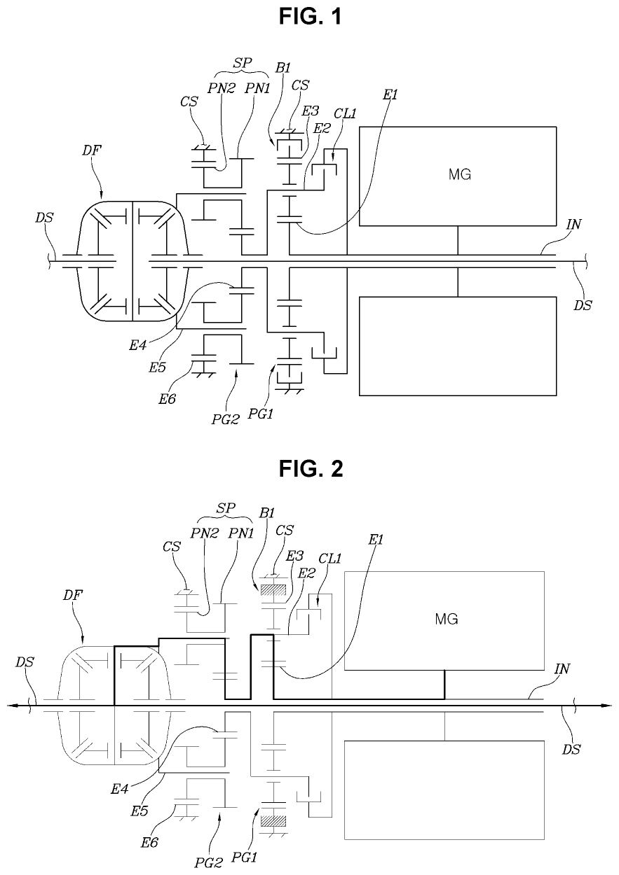

Referring to FIGS. 1 to 13, a powertrain apparatus for an electric vehicle according to exemplary embodiments of the present invention includes a motor MG connected to an input shaft IN, a first planetary gear train PG1, which is disposed coaxially with the motor MG and which includes a first rotation element E1, a second rotation element E2, and a third rotation element E3, a second planetary gear train PG2, which is disposed coaxially with the first planetary gear train PG1 and which includes a fourth rotation element E4, a fifth rotation element E5, and a sixth rotation element E6 and includes a step pinion SP, and a differential gear DF, which is disposed coaxially with the second planetary gear train PG2.

Here, the rotation elements of the first planetary gear train PG1 are configured to reduce the speed of the power transmitted from the input shaft IN and transmit the power to the second planetary gear train PG2, and the second planetary gear train PG2 is configured to reduce the speed of the power transmitted from the first planetary gear train PG1 and transmit the reduced power of the second planetary gear train to the differential gear DF via the fifth rotation element E5. The fifth rotation element E5 is a rotation shaft of the step pinion SP in which a first pinion and a second pinion are integrally connected to each other, and is directly connected to the differential gear DF.

In other words, the powertrains according to the exemplary embodiments of the present invention are configured such that the power from the motor MG is reduced in speed through the first planetary gear train PG1 and the second planetary gear train PG2 and is transmitted to the differential gear DF, whereby the driving force required to drive the vehicle is supplied to the drive wheels via the two driveshafts DS connected to the differential gear DF.

As illustrated in the drawings, one of the driveshafts DS is coupled to the differential gear DF through the centers of the first planetary gear train PG1, the second planetary gear train PG2, and the input shaft IN.

Consequently, since the powertrain apparatus according to various exemplary embodiments of the present invention is configured to have a single shaft structure and to be compact, the powertrain apparatus is easily and efficiently mounted in a vehicle, which is advantageous in ensuring internal space in the vehicle. Furthermore, since at least two changeable speeds are realized, it is easy to realize rapid acceleration performance and maximum speed performance even in a high-performance and large-sized vehicle, and it is also possible to improve electric mileage.

The first pinion PN1 of the step pinion SP has a diameter greater than that of the second pinion PN2, and the fourth rotation element E4 is engaged with the first pinion PN1 of the step pinion SP. The sixth rotation element E6 is engaged with the second pinion PN2 of the step pinion SP, and is fixed to the housing CS.

The above construction is common to all of the exemplary embodiments of the present invention.

In the various exemplary embodiments shown in FIG. 1, the first rotation element E1 is directly connected to the input shaft IN, the second rotation element E2 is directly connected to the fourth rotation element E4, and the third rotation element E3 is fixedly coupled to the housing CS.

The third rotation element E3 is fixedly coupled to the housing CS via a brake B1.

Accordingly, the power, which is input to the first rotation element E1 in the state in which the third rotation element E3 is fixed to the housing CS via the brake B1, is reduced in speed through the second rotation element E2 and is transmitted to the fourth rotation element E4, and is then reduced in speed through the second planetary gear train PG2 and transmitted to the differential gear DF, as illustrated in FIG. 2.

Here, the third rotation element E3 may also be fixedly coupled to the housing CS via a one-way clutch OWC and a dog clutch DOG, in place of the brake B1.

The fourth rotation element E4 is selectively connectable to the input shaft IN via a first clutch CL1.

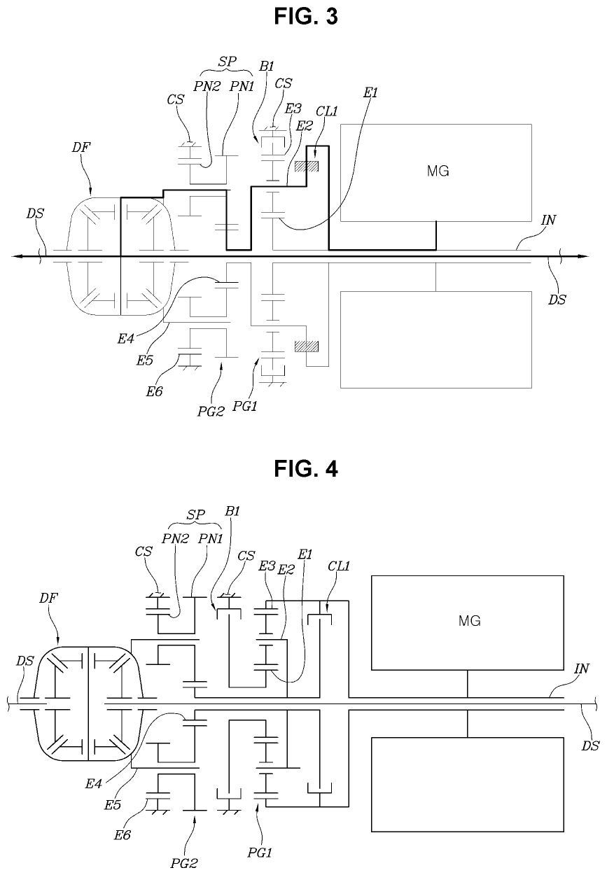

Accordingly, when the first clutch CL1 is engaged, the power from the input shaft IN is directly input to the second planetary gear train PG2 and is then reduced in speed thereby, rather than being reduced in speed by the first planetary gear train PG1, and is then transmitted to the differential gear DF, as illustrated in FIG. 3.

Of course, the power transmitted to the differential gear DF is transmitted to the drive wheels via both driveshafts DS.

In other words, the state of the first speed shown in FIG. 2 is realized when the brake B1 is engaged, and the state of the second speed shown in FIG. 3 is realized when the first clutch CL1 is engaged.

FIG. 4 illustrates various exemplary embodiments of the present invention. In the various exemplary embodiments of the present invention, the first rotation element EL1 is fixedly coupled to the housing CS, the second rotation element E2 is directly connected to the fourth rotation element E4, and the third rotation element E3 is directly connected to the input shaft IN.

The first rotation element E1 is fixedly coupled to the housing CS via the brake B1.

Here, the brake B1 is configured to enable the third rotation element E3 to be fixed to the housing CS in the various exemplary embodiments of the present invention, and is configured to enable the first rotation element E1 to be fixed to the housing CS in the various exemplary embodiments. Accordingly, the brake B1 is directed to fix the reactive elements of the first planetary gear train PG1.

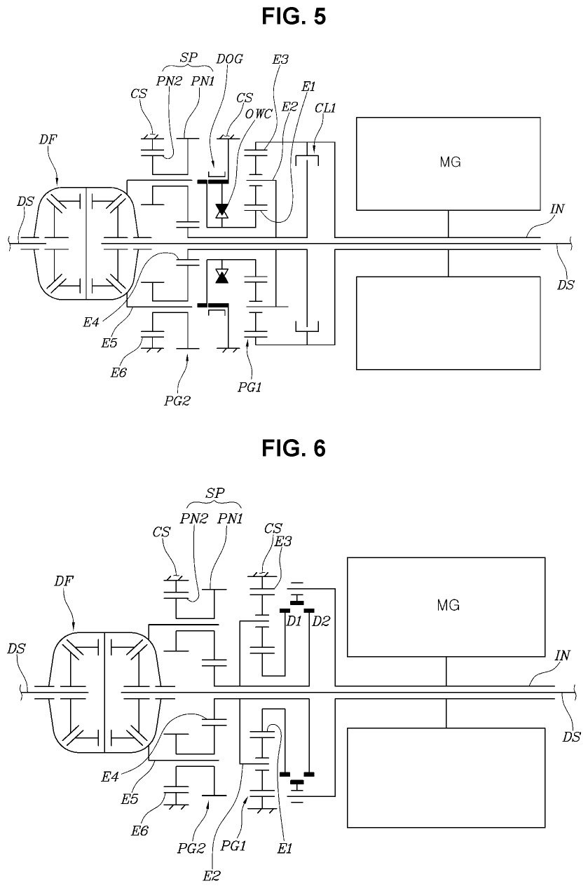

The brake B1 may be replaced with a one-way clutch OWC and a dog clutch DOG, as illustrated in FIG. 5. In the instant housing, the first rotation element E1 is configured for being fixedly coupled to the housing CS via the one-way clutch OWC and the dog clutch DOG.

In the exemplary embodiments of the present invention, the dog clutch is represented only as a single dog clutch DOG in the housing in which only one dog clutch is disposed in various exemplary embodiments of the present invention, and is represented as a first dog clutch D1 and a second dog clutch D2, to distinguish the same from each other, in the housing in which a plurality of dog clutches are included in on embodiment.

In the various exemplary embodiments of the present invention, in the state in which the first rotation element E1 is fixed by the brake B1, the power supplied to the input shaft IN from the motor MG is input to the third rotation element E3 while being reduced in speed, and is then output to the second rotation element E2. Subsequently, the power is reduced in speed through the second planetary gear train PG2 and is output to the differential gear DF, with the result that the power acts on the drive wheels as a first-speed driving force.

The fourth rotation element E4 is selectively connectable to the input shaft IN via the first clutch CL1.

Accordingly, when the first clutch CL1 is engaged in the state in which the brake B1 is disengaged, the power from the motor MG is transmitted to the fourth rotation element E4 through the input shaft IN and the first clutch CL1. Consequently, since the power is reduced in speed through the second planetary gear train PG2 without being reduced in speed through the first planetary gear train PG1 and is transmitted to the differential gear DF, the second-speed driving force, which has a rotation speed higher than that of the first-speed driving force, is supplied to the drive wheels.

FIG. 6 illustrates various exemplary embodiments of the present invention. In the various exemplary embodiments of the present invention, the first rotation element E1 and the second rotation element E2 are selectively connectable to the input shaft via the first dog clutch D1 and the second dog clutch D2, and the third rotation element E3 is fixed to the housing CS.

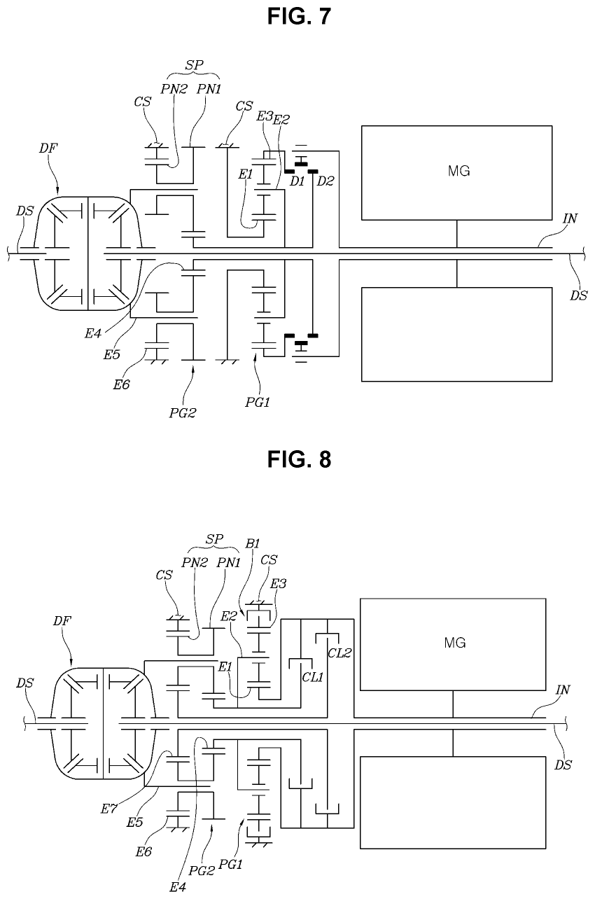

FIG. 7 illustrates a modification of the various exemplary embodiments. In the present modification, the first rotation element E1 is fixed to the housing CS and the third rotation element E3 and the second rotation element E2 are selectively connectable to the input shaft IN via the first dog clutch D1 and the second dog clutch D2.

The remaining components of the exemplary embodiments shown in FIGS. 6 and 8 are common to the various exemplary embodiments. Accordingly, when the first dog clutch D1 is engaged, the power from the input shaft IN is sequentially reduced in speed through the first planetary gear train PG1 and the second planetary gear train PG2, and is then transmitted to the differential gear DF. Meanwhile, when the second dog clutch D2 is engaged, the power from the input shaft IN is reduced in speed only through the second planetary gear train PG2, and is transmitted to the differential gear DF.

FIG. 8 illustrates various exemplary embodiments of the present invention. In the various exemplary embodiments of the present invention, the second planetary gear train PG2 further includes a seventh rotation element E7 engaged with the second pinion PN2 of the step pinion SP, and the seventh rotation element E7 is selectively connectable to the input shaft IN via the second clutch CL2.

In other words, the various exemplary embodiments are configured such that the power from the input shaft IN is directly supplied to the second pinion PN2 of the step pinion SP through the second clutch CL2 and the seventh rotation element E7.

In the various exemplary embodiments of the present invention, shown in FIG. 8, the first rotation element E1 is directly connected to the input shaft IN, the second rotation element E2 is directly connected to the fourth rotation element E4, and the third rotation element E3 is fixedly coupled to the housing CS.

Furthermore, the fourth rotation element E4 is selectively connectable to the input shaft IN via the first clutch CL1, and the third rotation element E3 is fixedly coupled to the housing CS via the brake B1.

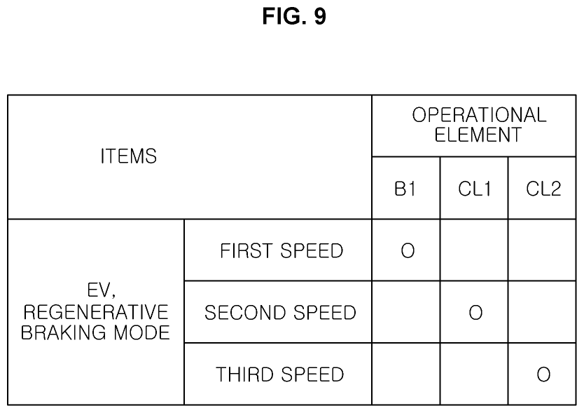

The various exemplary embodiments of the present invention, which is configured as described above, is operated according to the table shown in FIG. 9 to realize first to third speeds.

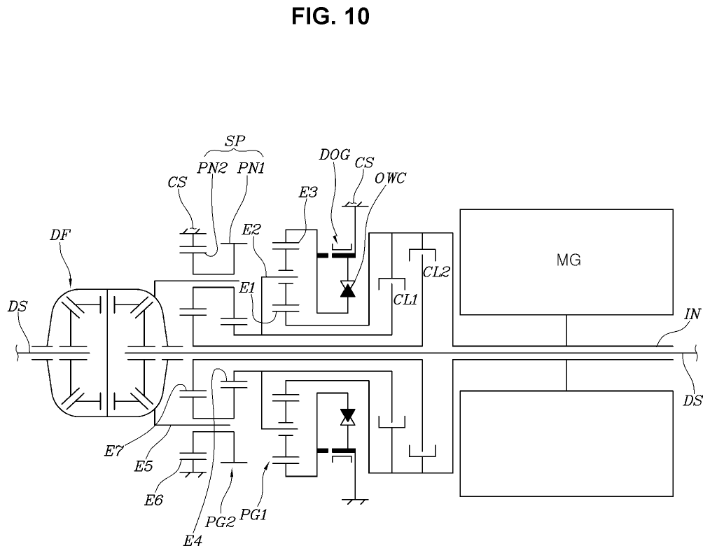

Alternatively, the third rotation element E3 may be fixedly coupled to the housing CS via a one-way clutch OWC and a dog clutch DOG, in place of the brake B1, as illustrated in FIG. 10.

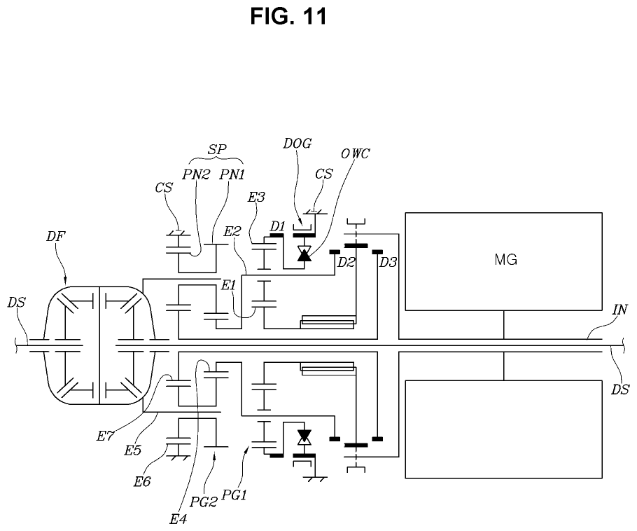

FIG. 11 illustrates a modification of the exemplary embodiment shown in FIG. 10 in which the first clutch CL1 and the second clutch CL2 are replaced with a second dog clutch D2 and a third dog clutch D3. In the present modification, the second planetary gear train PG2 further includes a seventh rotation element E7 engaged with the second pinion PN2 of the step pinion SP. The first rotation element E1 is directly connected to the input shaft IN and the third rotation element E3 is fixedly coupled to the housing CS via the one-way clutch OWC and the first dog clutch D1, which are disposed to be parallel to each other. The second rotation element E2 and the fourth rotation element E4 are directly connected to each other, and the second rotation element E2 and the seventh rotation element E7 are selectively connectable to the input shaft IN via the second dog clutch D2 and the third dog clutch D3.

Accordingly, the first speed is realized when the one-way clutch OWC and the first dog clutch D1 are engaged, the second speed is realized when the second dog clutch D2 is engaged, and the third speed is realized when the third dog clutch D3 is engaged.

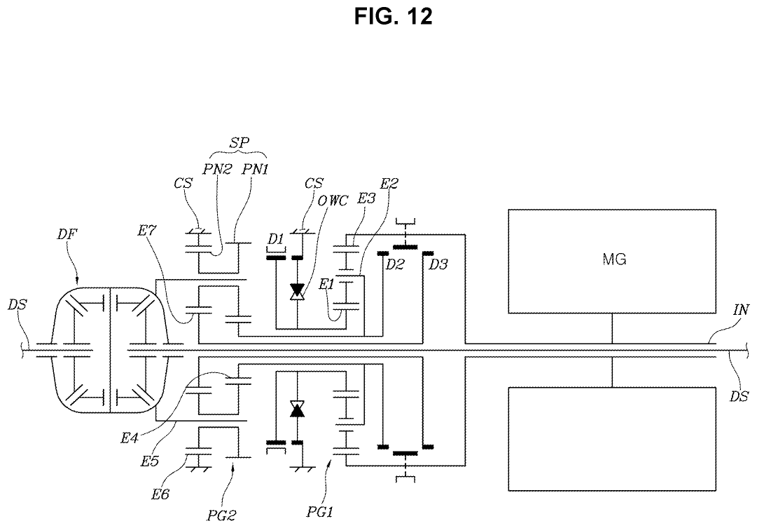

FIG. 12 illustrates a modification of the exemplary embodiment shown in FIG. 11 in which connection relationships of the first rotation element E1 and the third rotation element E3 are exchanged with each other. In the present modification, the second planetary gear train PG2 further includes a seventh rotation element E7 engaged with the second pinion PN2 of the step pinion SP. The first rotation element E1 is fixedly coupled to the housing CS via the one-way clutch OWC and the first dog clutch D1, which are disposed to be parallel to each other, and the third rotation element E3 is directly connected to the input shaft IN. The second rotation element E2 and the fourth rotation element E4 are directly connected to each other, and the second rotation element E2 and the seventh rotation element E7 are selectively connectable to the input shaft IN via the second dog clutch D2 and the third dog clutch D3.

The exemplary embodiment shown in FIG. 12 is also configured such that the first speed is realized when the one-way clutch OWC and the first dog clutch D1 are engaged, the second speed is realized when the second dog clutch D2 is engaged, and the third speed is realized when the third dog clutch D3 is engaged.

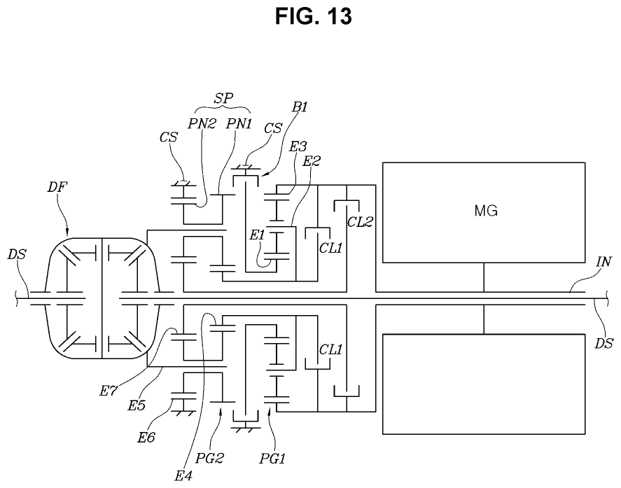

FIG. 13 illustrates various exemplary embodiments of the present invention. In the various exemplary embodiments of the present invention, the first rotation element E1 is fixedly coupled to the housing CS, the second rotation element E2 is directly connected to the fourth rotation element E4, and the third rotation element E3 is directly connected to the input shaft IN.

The fourth rotation element E4 is selectively connectable to the input shaft IN via the first clutch CL1, and the first rotation element E1 is fixedly coupled to the housing CS via the brake B1.

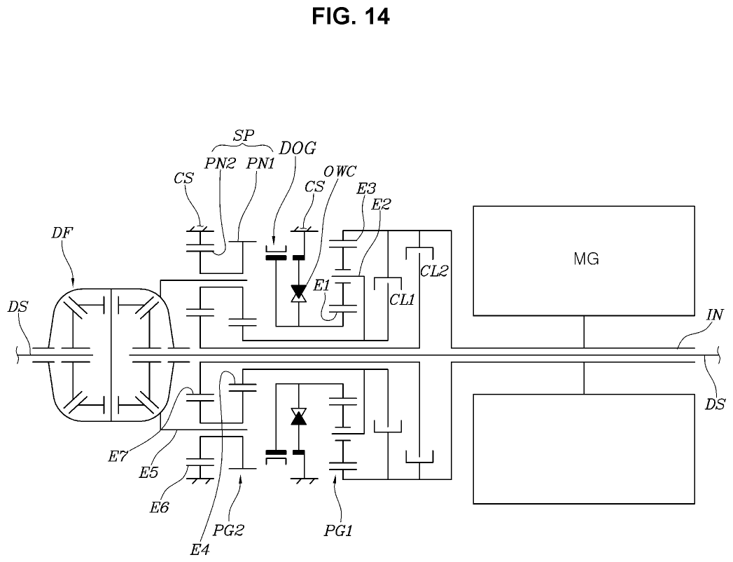

Alternatively, the first rotation element E1 may be fixedly coupled to the housing CS via a one-way clutch OWC and a dog clutch DOG, in place of the brake B1, as illustrated in FIG. 14.

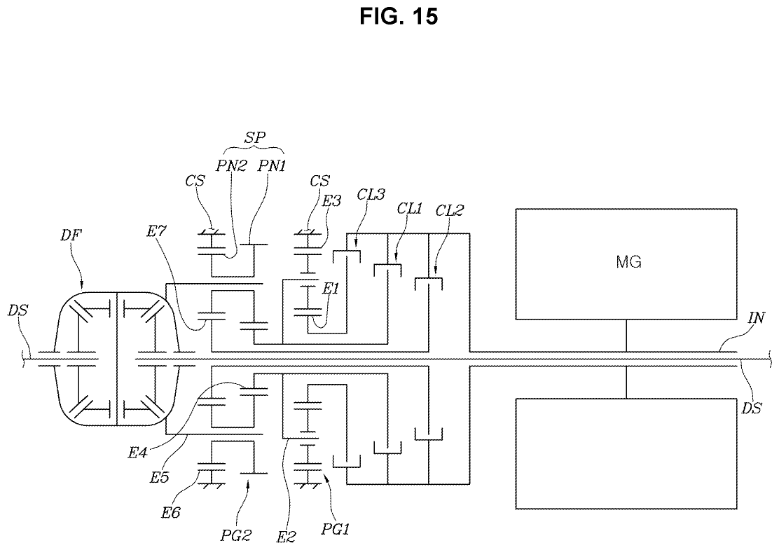

FIG. 15 illustrates various exemplary embodiments of the present invention. In the various exemplary embodiments of the present invention, the first rotation element E1 is selectively connectable to the input shaft IN via the third clutch CL3 and the second rotation element E2 is directly connected to the fourth rotation element E4. Furthermore, the third rotation element E3 is fixed to the housing CS and the fourth rotation element E4 is selectively connectable to the input shaft IN via the first clutch CL1.

In other words, the various exemplary embodiments are configured such that the third rotation element E3 of the first planetary gear train PG1 is continuously fixed to the housing CS and the first rotation element E1 is selectively connectable to the input shaft IN via the third clutch CL3.

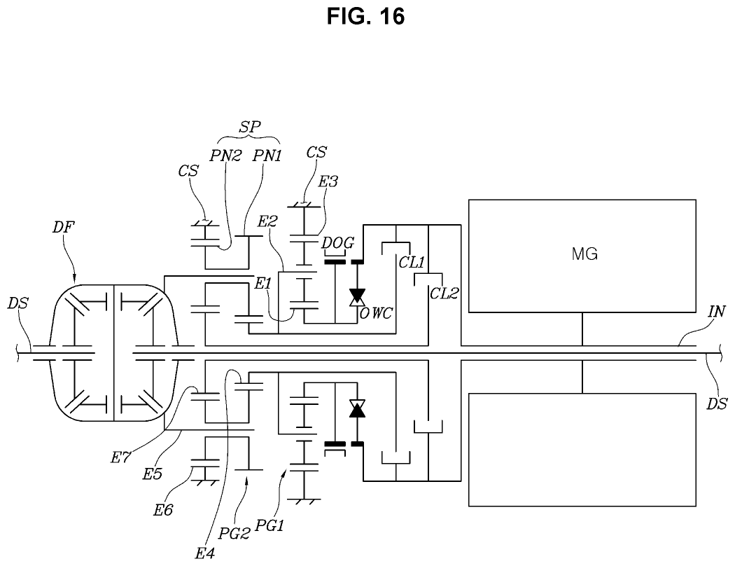

FIG. 16 illustrates a modification of the various exemplary embodiments shown in FIG. 16 in which the third clutch CL3 is replaced with a one-way clutch OWC and a dog clutch DOG.

In the present modification, the first rotation element E1 is selectively connectable to the input shaft IN via the one-way clutch OWC and the dog clutch DOG, which are disposed to be parallel to each other, the second rotation element E2 is directly connected to the fourth rotation element E4 and is selectively connectable to the input shaft IN via the first clutch CL1, and the third rotation element E3 is fixed to the housing CS.

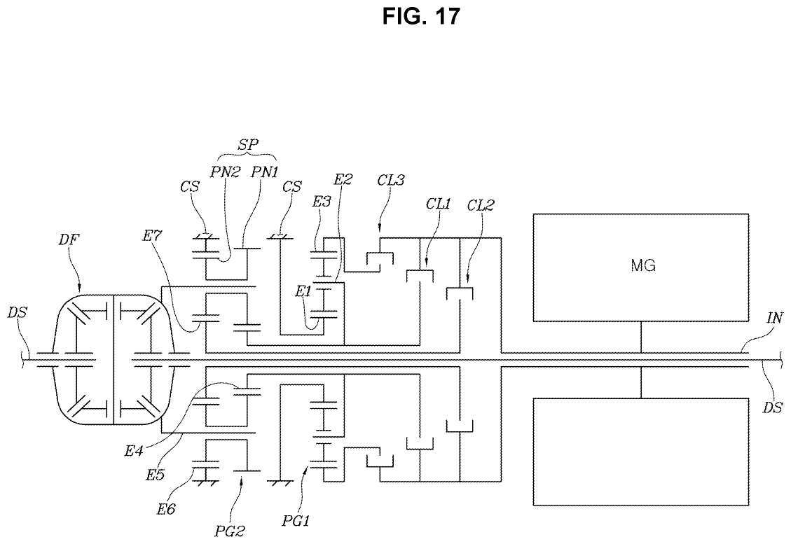

FIG. 17 illustrates a modification of the various exemplary embodiments shown in FIG. 15 in which the connection relationships of the first rotation element E1 and the third rotation element E3 are exchanged with each other. In the present modification, the first rotation element E1 is fixed to the housing CS, the second rotation element E3 is directly connected to the fourth rotation element E4 and is selectively connectable to the input shaft IN via the first clutch CL1, and the third rotation element E3 is selectively connectable to the input shaft IN via the third clutch CL3.

In other words, the various exemplary embodiments are modified such that the first rotation element E1 is continuously fixed to the housing CS and the third rotation element E3 is connectable to the input shaft IN.

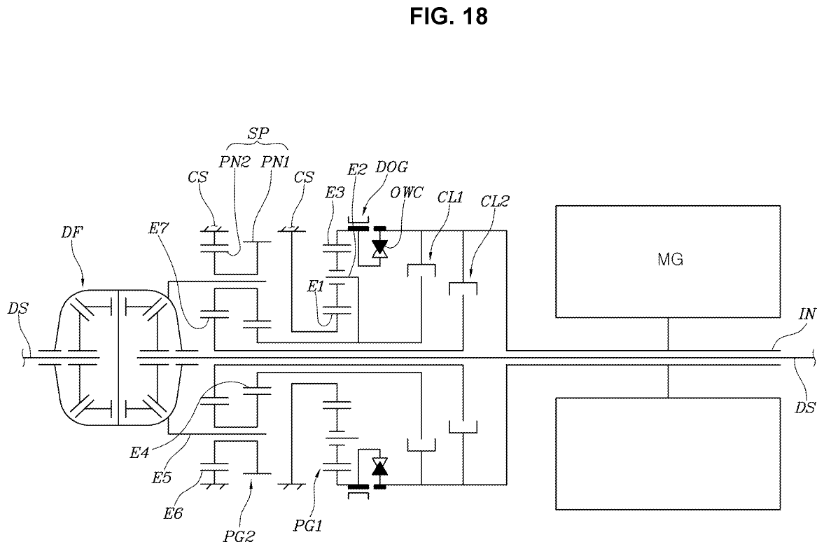

FIG. 18 illustrates a modification of the exemplary embodiment shown in FIG. 17 in which the third clutch CL3 is replaced with a one-way clutch OWC and a dog clutch DOG. In the present modification, the first rotation element E1 is fixed to the housing CS, the second rotation element E2 is directly connected to the fourth rotation element E4 and is selectively connectable to the input shaft IN via the first clutch CL1, and the third rotation element E3 is selectively connectable to the input shaft IN via the one-way clutch OWC and the dog clutch DOG, which are disposed to be parallel to each other.

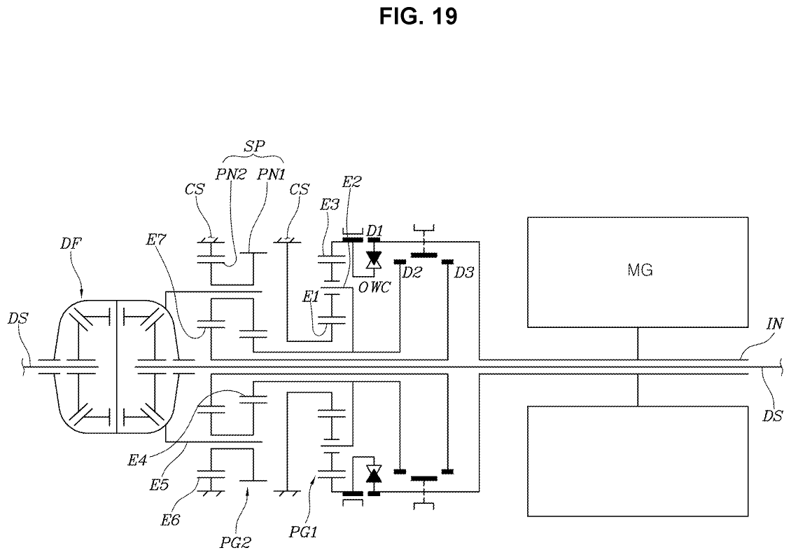

FIG. 19 illustrates a modification of the exemplary embodiment shown in FIG. 18 in which the first clutch CL1 and the second clutch CL2 are replaced with a second dog clutch D2 and a third dog clutch D3. In the present modification, the second planetary gear train PG2 further includes a seventh rotation element E7, engaged with the second pinion PN2 of the step pinion SP, and the first rotation element E1 is fixed to the housing CS. Furthermore, the third rotation element E3 is selectively connectable to the input shaft IN via the one-way clutch OWC and the first dog clutch D1, which are disposed to be parallel to each other, the second rotation element E2 and the fourth rotation element E4 are directly connected to each other, and the second rotation element E2 and the seventh rotation element E7 are selectively connectable to the input shaft IN via the second dog clutch D2 and the third dog clutch D3.

In the exemplary embodiments of the present invention, the first rotation element E1 of the first planetary gear train PG1 may be represented as a first sun gear, the second rotation element E2 may be represented as a first planet carrier, and the third rotation element E3 may be represented as a first ring gear. The first planetary gear train PG1 may be embodied as a double-pinion planetary gear train as well as a single-pinion planetary gear train.

Furthermore, the fourth rotation element E4 of the second planetary gear train PG2 may be represented as a second sun gear, and the fifth rotation element E5 may be represented as a second planet carrier. Furthermore, the sixth rotation element E6 may be represented as a second ring gear, and the seventh rotation element E7 may be represented as a third sun gear.

As is apparent from the above description, the powertrain apparatus of the present invention is constructed to have a compact structure to be easily and efficiently mounted in a vehicle, which is advantageous in ensuring internal space in the vehicle. Furthermore, Since various aspects of the present invention are directed to providing a plurality of changeable speeds, it is possible to easily realize desired rapid acceleration performance and maximum speed performance even in a high-performance and large-sized vehicle, and it is possible to improve electric mileage.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

Furthermore, the term of “fixedly connected” signifies that fixedly connected members always rotate at a same speed. Furthermore, the term of “selectively connectable” signifies “selectively connectable members rotate separately when the selectively connectable members are not engaged to each other, rotate at a same speed when the selectively connectable members are engaged to each other, and are stationary when at least one of the selectively connectable members is a stationary member and remaining selectively connectable members are engaged to the stationary member”.

The foregoing descriptions of specific exemplary embodiments of the present invention have been presented for purposes of illustration and description. They are not intended to be exhaustive or to limit the present invention to the precise forms disclosed, and obviously many modifications and variations are possible in light of the above teachings. The exemplary embodiments were chosen and described to explain certain principles of the present invention and their practical application, to enable others skilled in the art to make and utilize various exemplary embodiments of the present invention, as well as various alternatives and modifications thereof. It is intended that the scope of the present invention be defined by the Claims appended hereto and their equivalents.

What is claimed is:

1. A powertrain apparatus for a vehicle, the powertrain apparatus comprising:
a motor connected to an input shaft;
a first planetary gear train, which is disposed to be coaxial with the motor and which includes a first rotation element, a second rotation element, and a third rotation element;
a second planetary gear train, which is disposed to be coaxial with the first planetary gear train and which includes a fourth rotation element, a fifth rotation element, a sixth rotation element, and a step pinion; and
a differential gear, which is disposed to be coaxial with and engaged to the second planetary gear train,
wherein the first, second and third rotation elements of the first planetary gear train reduce a speed of power transmitted from the input shaft and transmit the reduced power to the second planetary gear train,
wherein the fourth, fifth and sixth rotation elements of the second planetary gear train reduce a speed of power transmitted from the first planetary gear train and transmit the reduced power of the second planetary gear train to the differential gear via the fifth rotation element, and
wherein the fifth rotation element is a rotation shaft of the step pinion, in which a first pinion and a second pinion are integrally connected to each other, and is directly connected to the differential gear.

2. The powertrain apparatus of claim 1, wherein one of driveshafts coupled to the differential gear is coupled to the differential gear through centers of the first planetary gear train, the second planetary gear train, and the input shaft.

3. The powertrain apparatus of claim 2, wherein the first pinion of the step pinion has a diameter greater than a diameter of the second pinion, the fourth rotation element is engaged with the first pinion of the step pinion, and the sixth rotation element is engaged with the second pinion of the step pinion and is fixed to a housing.

4. The powertrain apparatus of claim 3, wherein the first rotation element is fixedly connected to the input shaft, the second rotation element is fixedly connected to the fourth rotation element, and the third rotation element is selectively connectable to the housing.

5. The powertrain apparatus of claim 4, wherein the fourth rotation element is selectively connectable to the input shaft via a first clutch, and the first rotation element is selectively connectable to the housing via a brake.

6. The powertrain apparatus of claim 4, wherein the fourth rotation element is selectively connectable to the input shaft via a first clutch, and the third rotation element is coupled to the housing via a one-way clutch and a dog clutch.

7. The powertrain apparatus of claim 3, wherein the first rotation element and the second rotation element are selectively connectable to the input shaft via a first dog clutch and a second dog clutch, respectively, and the third rotation element is fixed to the housing.

8. The powertrain apparatus of claim 3, wherein the first rotation element is fixedly connected to the housing and the third rotation element and the second rotation element are selectively connectable to the input shaft via a first dog clutch and a second dog clutch, respectively.

9. The powertrain apparatus of claim 3, wherein the second planetary gear train further includes a seventh rotation element engaged with the second pinion of the step pinion and the seventh rotation element is selectively connectable to the input shaft via a second clutch.

10. The powertrain apparatus of claim 9, wherein the first rotation element is fixedly connected to the input shaft, the second rotation element is fixedly connected to the fourth rotation element, and the third rotation element is selectively connectable to the housing.

11. The powertrain apparatus of claim 10, wherein the fourth rotation element is selectively connectable to the input shaft via a first clutch, and the third rotation element is selectively connectable to the housing via a brake.

12. The powertrain apparatus of claim 10, wherein the fourth rotation element is selectively connectable to the input shaft via a first clutch, and the first rotation element is fixedly coupled to the housing via a one-way clutch and a dog clutch.

13. The powertrain apparatus of claim 3, wherein the second planetary gear train further includes a seventh rotation element engaged with the second pinion of the step pinion,
wherein the first rotation element is fixedly connected to the input shaft,
wherein the third rotation element is coupled to the housing via a one-way clutch and a first dog clutch, which are disposed to be parallel to each other,
wherein the second rotation element and the fourth rotation element are fixedly connected to each other, and
wherein the second rotation element and the seventh rotation element are selectively connectable to the input shaft via a second dog clutch and a third dog clutch, respectively.

14. The powertrain apparatus of claim 3, wherein the second planetary gear train further includes a seventh rotation element engaged with the second pinion of the step pinion,
wherein the first rotation element is coupled to the housing via a one-way clutch and a first dog clutch, which are disposed to be parallel to each other,
wherein the third rotation element is fixedly connected to the input shaft,
wherein the second rotation element is fixedly connected to the fourth rotation element, and
wherein the second rotation element and the seventh rotation element are selectively connectable to the input shaft via a second dog clutch and a third dog clutch, respectively.

15. The powertrain apparatus of claim 9, wherein the first rotation element is selectively connectable to the input shaft via a third clutch, the second rotation element is fixedly connected to the fourth rotation element, and the third rotation element is fixed to the housing.

16. The powertrain apparatus of claim 15, wherein the fourth rotation element is selectively connectable to the input shaft via a first clutch.

17. The powertrain apparatus of claim 9, wherein the first rotation element is selectively connectable to the housing via a one-way clutch and a dog clutch, which are disposed to be parallel to each other, the second rotation element is fixedly connected to the fourth rotation element and is selectively connectable to the input shaft via a first clutch, and the third rotation element is fixed to the input shaft.

18. The powertrain apparatus of claim 9, wherein the first rotation element is fixed to the housing, the second rotation element is fixedly connected to the fourth rotation element and is selectively connectable to the input shaft via a first clutch, and the third rotation element is selectively connectable to the input shaft via a third clutch.

19. The powertrain apparatus of claim 9, wherein the first rotation element is fixed to the housing, the second rotation element is fixedly connected to the fourth rotation element and is selectively connectable to the input shaft via a first clutch, and the third rotation element is selectively connectable to the input shaft via a one-way clutch and a dog clutch, which are disposed to be parallel to each other.

20. The powertrain apparatus of claim 3, wherein the second planetary gear train further includes a seventh rotation element engaged with the second pinion of the step pinion,
wherein the first rotation element is fixed to the housing,
wherein the third rotation element is selectively connectable to the input shaft via a one-way clutch and a first dog clutch, which are disposed to be parallel to each other,
wherein the second rotation element and the fourth rotation element are fixedly connected to each other, and
wherein the second rotation element and the seventh rotation element are selectively connectable to the input shaft via a second dog clutch and a third dog clutch, respectively.
